(19) United States
(12) Patent Application Publication
(10) Pub. No.: US 2018/0114166 A1
(43) Pub. Date: Apr. 26, 2018

(54) Retrieval Processing Apparatus and Method and Computer Program

(71) Applicant: Masahiro TAKASAKI, Tokyo (JP)

(72) Inventor: Yoshikazu TAKASAKI, Tokyo (JP)

(21) Appl. No.: 15/562,977

(22) PCT Filed: Feb. 3, 2016
(86) PCT No.: PCT/JP2016/053214

§ 371 Date: Sep. 29, 2017

(30) Foreign Application Priority Data
Apr. 2, 2015 (JP) 2015-075528

(51) Int. Cl. G06Q 10/06; G06Q 10/10; G06F 17/30

(52) U.S. Cl. CPC G06Q 10/06311; G06F 17/30; G06Q 10/06316; G06Q 10/1091

(57) ABSTRACT

A retrieval processing apparatus retrieving working hours and a workplace of an employee who can address a request of a user includes a human resource information DB and a work schedule information DB. When a retrieval condition for an employee who can address the request of the user and a retrieval request to retrieve an employee matching the retrieval condition are received from the user terminal, the employee matching the retrieval condition is identified by referring to one or a plurality of databases including at least the human resource information DB among the human resource information DB and the work schedule information DB according to the retrieval condition, and then information based on the human resource information DB and the work schedule information DB pertaining to the identified employee is extracted as a retrieval result. The extracted retrieval result is transmitted to the user terminal.

### BACKGROUND

### Technical Field

The present invention relates to a technology that retrieves information on working hours and a workplace of an employee who can address a request of a user on the basis of human resource and work schedule information of an employee.

### Related Art

While movement of people such as those going overseas and those coming from overseas is becoming more active all around the world in recent years with emergence of low-cost flights, relaxation of visa requirements and economic growth in developing countries, many of those working in local retail stores and restaurants can only speak their local language so that a person wishing to shop or dine needs courage to enter a store. It is convenient in such situation to be able to know whether there is a store nearby with someone who can speak a native language of the person wishing to shop or dine. Considering such circumstances, for example, there is a case where a sign says “English OK” or “Japanese OK”, which however may not mean that someone who can speak the language is present at all times or that all employees can speak the language, whereby the person entering a store or an office may not be served as he desires.

Moreover, there is a case where a person requires someone who not only speaks his native language but also has a predetermined qualification. When a person suddenly falls sick, for example, he may wish to seek a qualified person or technical expert who can speak a predetermined language nearby such as a Japanese-speaking doctor or an English-speaking pharmacist. The person may also wish to seek a store or the like where a predetermined language is available. The person may also wish to seek a combination of a language and a type of business, merchandise carried in a store or a service nearby such as a hamburger shop with someone speaking Japanese, a store carrying a rice cooker and having someone who speaks Japanese, or a taxi driven by an English-speaking driver. Furthermore, the person may wish to know a popular one from among the qualified persons and technical experts or the stores.

Such retrieving of information being the combination of the language and the type of business, merchandise and service is also useful for those wishing to work overseas, because a person wishing to work overseas can know where to find a type of business he desires or a job in which he can make use of his experience as well as whether there is someone who speaks his language working there, and can thus seek employment in the language he speaks.

In this respect, JP 2013-149190 A proposes a guide service management server apparatus including: a participation processing unit that makes a virtual participant participate in a Social Networking Service (SNS) on a network, the virtual participant having preset personal information including at least a language used and a guide area; a navigator recruiting unit that recruits a navigator who can guide the guide area in the language used and establishes friendship on the SNS between the virtual participant and a navigator applicant; a guide requirement acquisition unit that acquires through the virtual participant a guide requirement which is posted on the SNS by a person seeking a guide and having friendship on the SNS with the virtual participant, and in which a language used and a current location can be identified; and a guide requesting unit that mediates the guide requirement by posting, on the SNS, a message for navigator according to the guide requirement through the virtual participant and requests the navigator gathered by the recruitment to give a guide.

### SUMMARY

However, according to JP 2013-149190 A adapted to recruit a navigator who can use a predetermined language as occasion demands, the navigator needs to be recruited beforehand so that a requirement cannot be addressed when, for example, a person wishes to find someone who speaks a desired language immediately. Moreover, in many cases, a user of a service provided by the apparatus described in JP 2013-149190 A may need not just someone who speaks a desired language but something more than the language such as a doctor who speaks a predetermined language or a store staff who can explain merchandise.

Accordingly, an object of the present invention is to be able to retrieve information on when and where a person who can address a predetermined request is available on the basis of human resource information such as nationality, an available language, and an acquired qualification of an employee as well as work schedule information of the employee.

In order to achieve the aforementioned object, according to one aspect of the present invention, there is provided a retrieval processing apparatus which retrieves working hours and a workplace of an employee who can address a request of a user and is configured to be able to communicate with a user terminal used by the user through a network, the apparatus including: a human resource information storage unit that stores human resource information related to an attribute or capability of an employee; a work schedule information storage unit that stores work schedule information of an employee; a retrieval request reception unit that receives, from the user terminal, a retrieval condition for an employee who can address the request of the user and a retrieval request to retrieve an employee matching the retrieval condition; an identification processing unit that identifies the employee matching the retrieval condition by referring to one or a plurality of storage units including at least the human resource information storage unit among the human resource information storage unit and the work schedule information storage unit according to the retrieval condition; an extraction processing unit that extracts, as a retrieval result, a piece of information based on the human resource information storage unit and the work schedule information storage unit pertaining to the employee identified; and a result transmission unit that transmits the extracted retrieval result to the user terminal.

The retrieval processing apparatus may also be adapted to further include a clock-in/out information storage unit that stores clock-in/out information of the employee, where the identification processing unit identifies the employee matching the retrieval condition by referring to one or a plurality of storage units including at least the human resource information storage unit among the human resource information storage unit, the work schedule information storage unit and the clock-in/out information storage unit according to the retrieval condition, and the extraction processing unit extracts, as a retrieval result, a piece of information based on the human resource information storage unit, the work schedule information storage unit, and the clock-in/out information storage unit pertaining to the employee identified.

The retrieval processing apparatus may also be configured to be able to communicate with a time recorder acquiring the clock-in/out information of the employee through the network, and include a clock-in/out information reception unit that receives the clock-in/out information of the employee from the time recorder.

The retrieval processing apparatus may also be adapted to further include a determination processing unit that refers to the work schedule information storage unit and the clock-in/out information storage unit and determines whether or not the identified employee works according to a work schedule on the basis of the work schedule information and the clock-in/out information of the identified employee, where the extraction processing unit extracts, as a retrieval result, a piece of information based on the human resource information storage unit, the work schedule information storage unit and the clock-in/out information storage unit pertaining only to an employee working according to the work schedule out of the identified employee, on the basis of a determination on whether or not the identified employee works according to the work schedule.

The retrieval processing apparatus may also be adapted such that, on the basis of the determination on whether or not the identified employee works according to the work schedule, the extraction processing unit extracts, as a retrieval result, a piece of information based on the human resource information storage unit, the work schedule information storage unit and the clock-in/out information storage unit pertaining to the employee working according to the work schedule among the identified employee and extracts, as a retrieval result, a piece of information based on the human resource information storage unit and the clock-in/out information storage unit pertaining to an employee not working according to the work schedule.

Moreover, according to another aspect of the preset invention, there is provided a retrieval processing method employed to retrieve working hours and a workplace of an employee who can address a request of a user, where a computer configured to be able to communicate with a user terminal used by the user through a network includes: a human resource information storage unit that stores human resource information related to an attribute or capability of an employee; and a work schedule information storage unit that stores work schedule information of an employee, and executes: processing that receives, from the user terminal, a retrieval condition for an employee who can address the request of the user and a retrieval request to retrieve an employee matching the retrieval condition; processing that identifies the employee matching the retrieval condition by referring to one or a plurality of storage units including at least the human resource information storage unit among the human resource information storage unit and the work schedule information storage unit according to the retrieval condition; processing that extracts, as a retrieval result, a piece of information based on the human resource information storage unit and the work schedule information storage unit pertaining to the employee identified; and processing that transmits the extracted retrieval result to the user terminal.

Furthermore, according to yet another aspect of the present invention, there is provided a computer program retrieving working hours and a workplace of an employee who can address a request of a user, where a computer configured to be able to communicate with a user terminal used by the user through a network includes: a human resource information storage unit that stores human resource information related to an attribute or capability of an employee; and a work schedule information storage unit that stores work schedule information of an employee, and the computer program causes the computer to execute: processing that receives, from the user terminal, a retrieval condition for an employee who can address the request of the user and a retrieval request to retrieve an employee matching the retrieval condition; processing that identifies the employee matching the retrieval condition by referring to one or a plurality of storage units including at least the human resource information storage unit among the human resource information storage unit and the work schedule information storage unit according to the retrieval condition; processing that extracts, as a retrieval result, a piece of information based on the human resource information storage unit and the work schedule information storage unit pertaining to the employee identified; and processing that transmits the extracted retrieval result to the user terminal.

According to the present invention, a person who can address a predetermined request at predetermined time and location can be found on the basis of the human resource information and the work schedule information of the employee.

### BRIEF DESCRIPTION OF DRAWINGS

FIG. 1 is a functional block diagram illustrating a function included in a retrieval processing apparatus according to a first embodiment of the present invention;

FIG. 2 is a table illustrating an example of data stored in a store information DB in the retrieval processing apparatus of the present embodiment;

FIG. 3 is a table illustrating an example of data stored in a human resource information DB in the retrieval processing apparatus of the present embodiment;

FIG. 4 is a table illustrating an example of data stored in a work schedule information DB in the retrieval processing apparatus of the present embodiment;

FIG. 5 is a table illustrating an example of data stored in a clock-in/out information DB in the retrieval processing apparatus of the present embodiment;

FIG. 6 is a sequence diagram illustrating the flow of processing performed by the retrieval processing apparatus of the present embodiment;

FIG. 7 is a processing flow diagram illustrating the flow of processing performed by the retrieval processing apparatus of the present embodiment;

FIG. 8 is a functional block diagram illustrating a function included in a retrieval processing apparatus according to a second embodiment of the present invention;

FIG. 9 is a processing flow diagram illustrating the flow of another processing performed by the retrieval processing apparatus of the present embodiment; and

FIG. 10 is a processing flow diagram illustrating the flow of processing performed by the retrieval processing apparatus of the present embodiment.

### DETAILED DESCRIPTION

A retrieval processing apparatus according to an embodiment of the present invention will now be described with reference to the drawings.

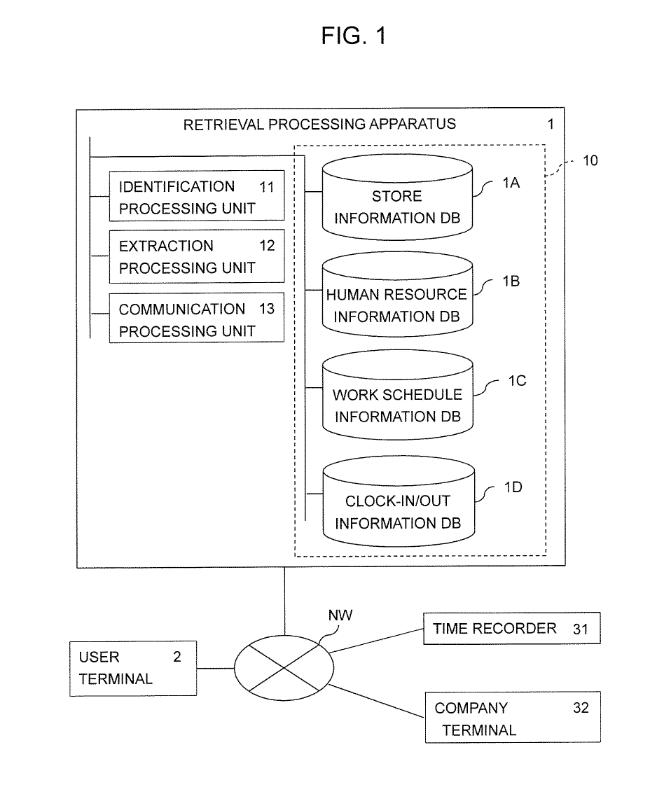

First, FIG. 1 illustrates a configuration of a retrieval processing apparatus 1 according to a first embodiment.

The retrieval processing apparatus 1 is an apparatus that includes a database storing information on human resources or work of an employee of a store or company and provides, to a user, an information retrieval service based on the information stored in the database on a predetermined website, and is configured to be able to communicate with a user terminal 2 used by the user, a time recorder 31 used by an employee when he clocks in/out to/from a store, and a company terminal 32 installed in a company for which the employee works through a network NW such as the Internet.

The retrieval processing apparatus 1 is realized by a so-called server computer or the like and uses hardware resources including a Central Processing Unit (CPU), a Random Access Memory (RAM), a Read Only Memory (ROM) and a hard disk drive as well as a software resource including a computer program run by the CPU to configure a functional block including an identification processing unit 11, an extraction processing unit 12, a communication processing unit 13, a store information DB 1A, a human resource information DB 1B, a work schedule information DB 1C and a clock-in/out information DB 1D.

Here, the store information DB 1A, the human resource information DB 1B, the work schedule information DB 1C, and the clock-in/out information DB 1D make up a human resource/labor system 10 in which information on human resources and labor of a company is accumulated. In an embodiment of the present invention, the human resource/labor system 10 may be incorporated into the retrieval processing apparatus 1 or constructed separately as an independent system such that information accumulated in the human resource/labor system 10 is provided to the retrieval processing apparatus 1 as appropriate, where arrangement or structure of resources can be modified in design as appropriate.

The store information DB 1A is a storage storing information on a store or an office in which an employee works.

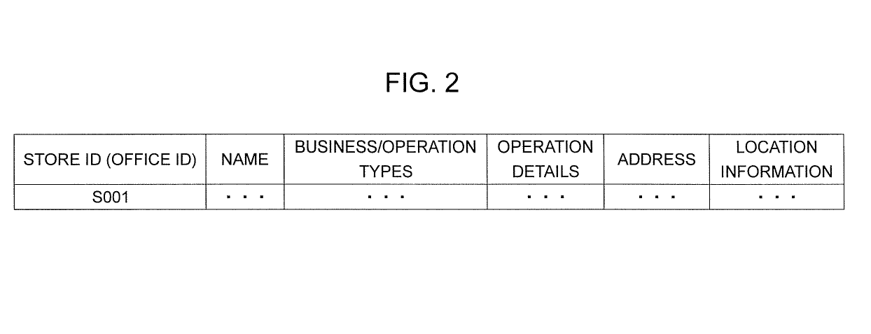

As illustrated in FIG. 2, for example, the store information DB 1A stores information on the store such as a store ID identifying the store, a store name, business/operation types, operation details, an address, and location information indicating a location on a map.

The human resource information DB 1B is a storage storing human resource information on an attribute or capability of the employee working in the store or office.

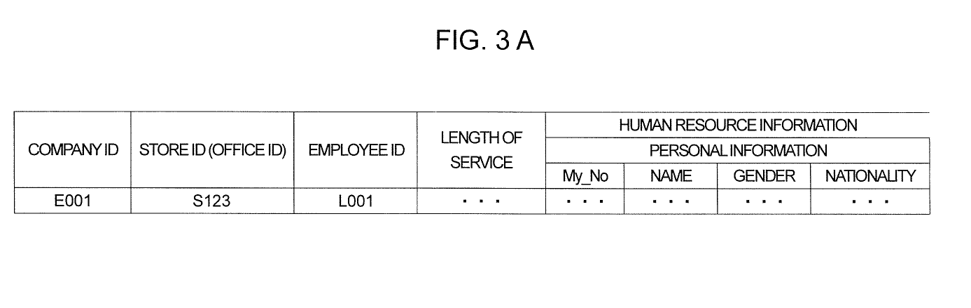

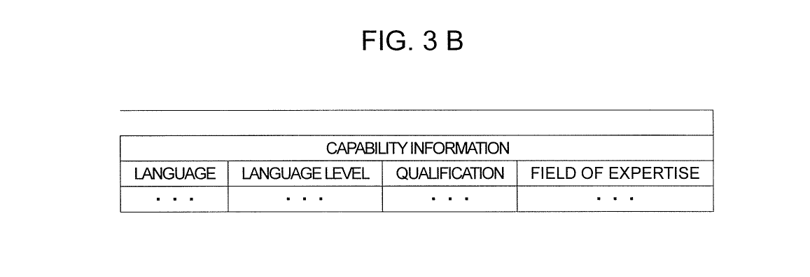

For each employee ID identifying the employee, the human resource information DB 1B stores for example a company ID of a company for which the employee works, a store ID of a store, and human resource information including personal information and capability information as illustrated in FIG. 3.

Here, the personal information included in the human resource information indicates attributes of the employee such as a My Number, a name, gender and nationality of the employee.

The capability information is information pertaining to capability performed according to a request from a user such as an available language, a language level, a qualification held and a field of expertise of the employee.

One can grasp what type of employee works in the store or office by referring to the human resource information DB 1B.

The work schedule information DB 1C is a storage storing work schedule information related to a work schedule or an operation schedule of an employee and a shift at an operation site.

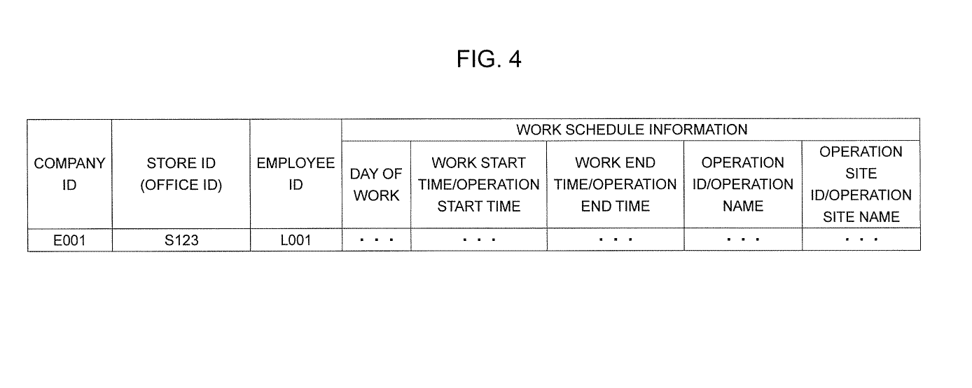

As illustrated in FIG. 4, for example, the work schedule information DB 1C stores for each employee ID the work schedule information including a day of work, work start time and work end time as well as operation schedule information such as operation start time, operation end time, operation details, and an operation site.

One can grasp which employee is scheduled to perform what operation at which time and location by referring to the work schedule information DB 1C.

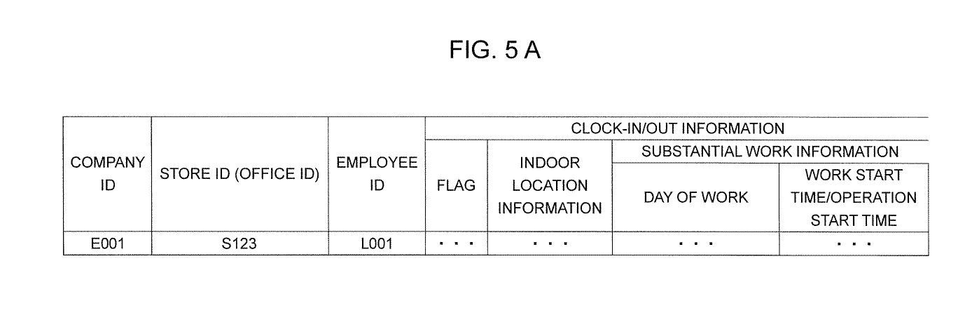

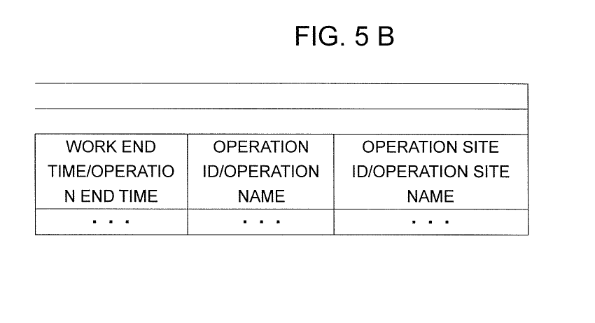

The clock-in/out information DB 1D stores clock-in/out information for each employee ID as illustrated in FIG. 5, for example.

The clock-in/out information is generated from data punched in the time recorder 31 and includes a flag indicating a clock-in/clock-out status, indoor location information indicating the location of an employee, and substantial work information. The substantial work information includes a day of work, work start time and work end time as well as operation information such as operation start time, operation end time, an operation ID, an operation name, an operation site ID, and an operation site name.

One can grasp whether or not a predetermined employee is on duty as well as what operation is performed at which location by the employee by referring to the clock-in/out information DB 1D.

The flag indicating the clock-in/clock-out status of the employee is switched by punching in or punching out, for example. A flag indicating that the employee is at work is set by punching in, whereas a flag indicating that the employee is not at work is set by punching out, for example.

The indoor location information indicates a detailed location such as a floor or a room on/in which the employee works within the office and can be acquired by various methods such as communicating with an ID tag carried by the employee and getting information from a GPS-equipped mobile terminal.

The clock-in/out information DB 1D can include information indicating a clock-in location (location at which an operation is started) or a clock-out location (location at which an operation is ended) of the employee, where such location information can be acquired by receiving location information preset in the time recorder 31. In another example, there is provided beforehand a table in which individual identification information of each time recorder 31 is associated with an installed location of each time recorder 31, so that one gets hold of the installed location associated with the individual identification information by acquiring the individual identification information along with the clock-in/out information from each time recorder 31. One regards such installed location of the time recorder 31 as the clock-in or clock-out location to thus be able to grasp when and where the employee clocks in or out.

When receiving a retrieval condition for an employee who can address a request of a user and a retrieval request to retrieve an employee matching the retrieval condition from the user terminal 2, the identification processing unit 11 executes processing of identifying the employee matching the retrieval condition by referring to one or a plurality of databases including at least the human resource information DB 1B among the store information DB 1A, the human resource information DB 1B, the work schedule information DB 1C and the clock-in/out information DB 1D according to the retrieval condition. That is, there is a case where the human resource information DB 1B alone is referenced and a case where all the store information DB 1A, the human resource information DB 1B, the work schedule information DB 1C and the clock-in/out information DB 1D are referenced depending on the retrieval condition.

Here, the retrieval condition set by the user includes any one or a plurality of pieces of information including at least human resource information of the employee among information making up store information or office information as well as the human resource information, work schedule information, clock-in/out information and operation information of the employee.

Accordingly, for example, the employee matching the retrieval condition is identified by referring to the human resource information DB 1A alone when the retrieval condition includes only the human resource information of the employee. When the retrieval condition includes the store information as well as the human resource information, the work schedule information, the clock-in/out information and the operation information of the employee, the employee matching the retrieval condition is identified by referring to all the store information DB 1A, the human resource information DB 1B, the work schedule information DB 1C, and the clock-in/out information DB 1D.

The extraction processing unit 12 extracts, as a retrieval result, a piece of information that pertains to the employee identified by the identification processing unit 11 and is based on the store information DB 1A, the human resource information DB 1B, the work schedule information DB 1C, and the clock-in/out information DB 1D.

Accordingly, when the user retrieves information on a restaurant where service is available in English at a predetermined location and time, for example, a restaurant in which an English-speaking employee works at the predetermined location and time is extracted as a retrieval result.

The communication processing unit 13 is a functional unit that executes processing of transmitting/receiving various pieces of data to/from the user terminal 2 and the time recorder 31 through the network NW.

The communication processing unit 13 can receive the retrieval request and transmit the retrieval result from/to the user terminal 2 as well as receive the clock-in/out information of the employee from the time recorder 31.

The user terminal 2 is a terminal used by the user and can also be a mobile terminal such as a mobile phone, a Personal Digital Assistant (PDA), or a tablet terminal or a so-called personal computer capable of data communication, the user terminal including an input unit such as a touch panel and/or a keyboard, an output unit such as a display and a speaker, and a communication unit enabling data communication through the network NW.

The user uses the user terminal 2 and accesses a predetermined website to be able to use the information retrieval service provided by the retrieval processing apparatus 1.

The time recorder 31 is a device recording and managing clock-in/out time as well as operation start/end time of an employee, and is installed at a plurality of locations inside and outside the employee's workplace or office. When the employee comes to work or leaves work, for example, the time recorder acquires an employee ID by reading an IC card issued as biometric authentication or a staff ID card and records the clock-in time or clock-out time. The clock-in/out time makes up the clock-in/out information along with information on a clock-in/out location, and the clock-in/out information is transmitted to the retrieval processing apparatus 1 along with the employee ID identifying the employee through the network NW and stored in the clock-in/out information DB 1D.

Note that as described above, the information on the clock-in/out location is made up of the location information preset in the time recorder 31 or the location information associated in advance with the individual identification information of each time recorder 31 in the predetermined table held by the retrieval processing apparatus 1.

The company terminal 32 is a terminal installed in the company the employee works for, and can also be a so-called personal computer. The company terminal 32 creates the employee's work schedule information or the like, which is provided to the retrieval processing apparatus 1.

The flow of processing performed by the retrieval processing apparatus 1 according to the present embodiment will now be described.

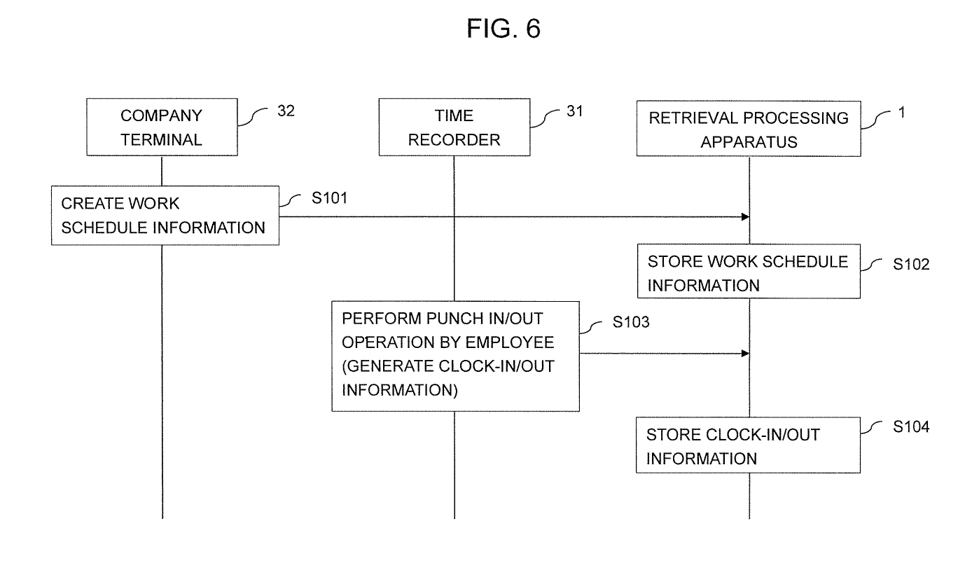

First, there will be described the flow of processing in which the time recorder 31 provides the clock-in/out information of the employee to the retrieval processing apparatus 1 with reference to FIG. 6.

The work schedule information is created in the company terminal 32 (S101), provided to the retrieval processing apparatus 1 and stored in the work schedule information DB 10 (S102).

When the employee clocks in/out or starts/ends an operation, the time recorder 31 acquires the employee ID by reading the IC card issued as the biometric authentication or the staff ID card, records the clock-in/out time or the operation start/end time of the employee, and creates the clock-in/out information including these pieces of information (S103).

Note that as described above, the location information making up the clock-in/out location is the location information in the time recorder 31 when it is preset therein, whereas the individual identification information makes up the location information in the clock-in/out information created by the time recorder 31 when the location information is associated with the individual identification information of each time recorder 31 in the predetermined table held by the retrieval processing apparatus 1.

When the clock-in/out information associated with the employee ID is transmitted timely from the time recorder 31 to the retrieval processing apparatus 1, the retrieval processing apparatus 1 refers to the human resource information DB 1B and stores the clock-in/out information in association with the employee ID (S104).

As a result, the clock-in/out information of the employee is accumulated in the retrieval processing apparatus 1 so that one can grasp a current work status of the employee.

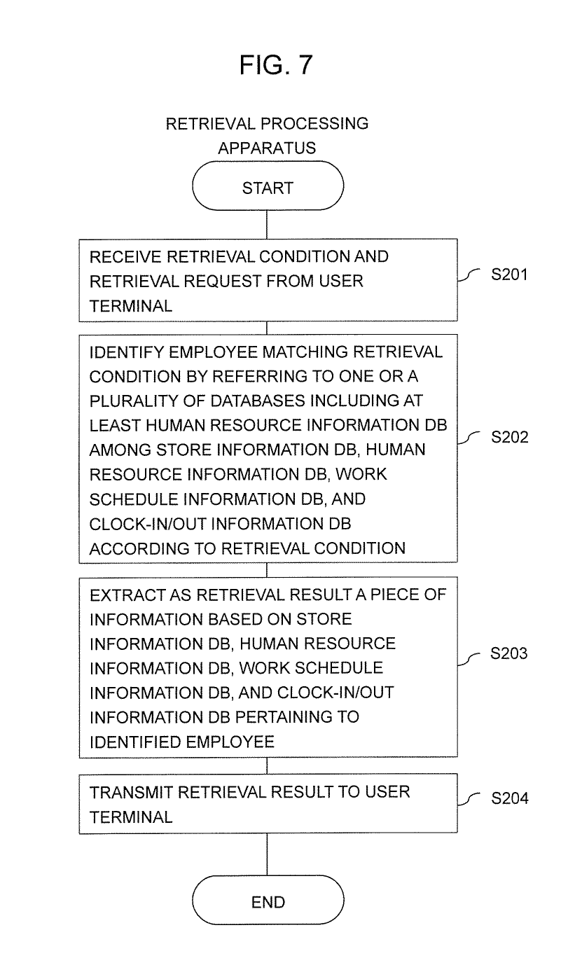

There will now be described the flow of processing performed when a retrieval request to retrieve an employee matching a desired retrieval condition is received from a user, with reference to FIG. 7.

First, the retrieval condition and the retrieval request are received from the user terminal 2 on a predetermined website providing the information retrieval service (S201).

Here, the retrieval condition includes items making up the store information or office information, the human resource information, the work schedule information, the clock-in/out information, the operation schedule information and the operation information, and allows one to figure out when and where the user needs what type of person. The user being a foreign traveler selects a desired type of business/operation to be able to retrieve information on a store or an office with an employee who is present at specified time and location and speaks a predetermined language, for example.

Note that while the retrieval condition includes the items making up the store information, the human resource information, the work schedule information, the clock-in/out information, the operation schedule information and the operation information, the user does not necessarily have to specify a condition for all the items but can request to perform retrieval by specifying a condition for an arbitrary item.

The retrieval processing apparatus 1 identifies an employee matching the retrieval condition by referring to one or a plurality of databases including at least the human resource information DB 1B among the store information DB 1A, the human resource information DB 1B, the work schedule information DB 1C, and the clock-in/out information DB 1D according to the retrieval condition received from the user (S202).

The reference database changes according to the retrieval condition. That is, there is no need to refer to the clock-in/out information DB 1D to grasp a current work status when a retrieval target is an employee having predetermined capability at specific date and time in the future, and there is no need to refer to the work schedule information DB 1C when a retrieval target is an employee having predetermined capability at the present time. It is also reasonable, in another embodiment, to refer to all databases in each retrieval regardless of the necessity according to the retrieval condition.

Note that at least the human resource information DB 1B needs to be referenced by the identification processing unit 11 since the information retrieval service provided by the retrieval processing apparatus 1 retrieves the employee desired by the user.

The extraction processing unit 12 extracts, as a retrieval result, a piece of information that pertains to the identified employee and is based on the store information DB 1A, the human resource information DB 1B, the work schedule information DB 1C, and the clock-in/out information DB 1D (S203).

Note that the amount of information on the identified employee extracted from each database can be modified as appropriate by the user on a predetermined website providing the information retrieval service or an administrator or operator of the website.

The extracted retrieval result is put into a predetermined form or the like and transmitted to the user terminal 2 (S204).

The predetermined form can be a list in which information can be sorted by item such as the degree of match with respect to the retrieval condition, or a map of a location specified in the retrieval condition by the user with an indication of a predetermined identifier of a location at which the employee currently works or is scheduled to work, but it is not to be limited to any particular method.

The user can thus find a person who can address a predetermined request at predetermined time and location on the basis of the human resource information and the work schedule information of the employee.

Accordingly, for example, a person visiting from overseas can retrieve in real time where in the neighborhood a person who speaks a desired language or can address what he desires is located. This as a result makes a visitor from overseas feel less anxious and more satisfied on site. Moreover, a local store or office has an increased chance of attracting the visitor from overseas. The skill of the employee working in the store or office can be improved as well by studying a foreign language or the like. Moreover, the store or office is expected to recruit more foreigners, thereby contributing more to the international society.

A person planning a visit from overseas can also retrieve where a person who speaks a desired language or can address what he desires is in the vicinity of a destination of the visit on scheduled date and time frame of the visit. This as a result allows the person to make a reservation to visit a store or an office in advance. A person wishing to work overseas can retrieve a desired location of work, a desired type of business, a skill he wishes to acquire, and a task to which he can contribute and, when a retrieved store or office has an employee who can speak with the person, he can consult with the employee in advance via e-mail or a letter to thus be able to expand the chance of job offers and applications globally.

Moreover, the aforementioned retrieval can be realized by just adding the aforementioned technology to an existing human resource/labor information management system where there is no need to register information in order to attract customers and offer jobs from/to people from overseas and thus no increase in time and effort. Information is updated at all times so that real-time information can be sent out.

Next, a retrieval processing apparatus according to a second embodiment of the present invention will be described.

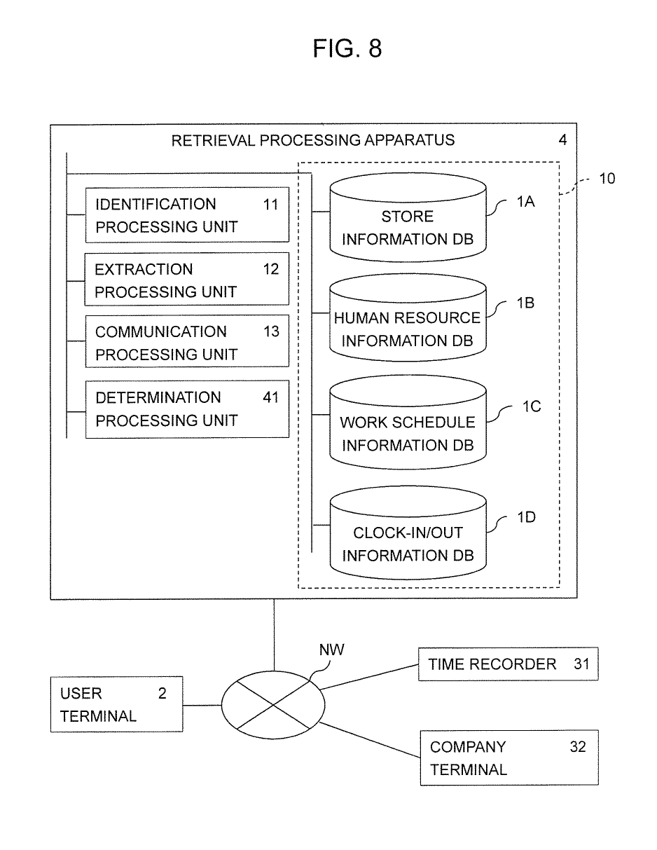

As illustrated in FIG. 8, a retrieval processing apparatus 4 of the second embodiment is realized by a so-called server computer or the like and uses hardware resources including a Central Processing Unit (CPU), a Random Access Memory (RAM), a Read Only Memory (ROM) and a hard disk drive as well as a software resource including a computer program run by the CPU to configure a functional block including an identification processing unit 11, an extraction processing unit 12, a communication processing unit 13, a store information DB 1A, a human resource information DB 1B, a work schedule information DE 1C and a clock-in/out information DB 1D that are similar to the ones in the first embodiment, and a determination processing unit 41.

The determination processing unit 41 executes determination processing of referring to the work schedule information DB 1C and the clock-in/out information DB 1D and determining whether or not an employee works according to a work schedule, on the basis of work schedule information and clock-in/out information of the employee identified by the identification processing unit 11.

That is, the employee is determined to be working according to the work schedule when information matches as a result of collating the work schedule information and the clock-in/out information. On the other hand, the employee is determined to not be working according to the work schedule when the information does not match as a result of the collation. Note that a flag stored in the clock-in/out information DB 1C may be referenced to determine whether or not the employee works according to the work schedule.

On the basis of the determination on whether or not the employee identified by the identification processing unit 11 works according to the work schedule, the extraction processing unit 12 of the present example extracts, as a retrieval result, a piece of information based on the store information DB 1A, the human resource information DB 1B, the work schedule information DB 1C and the clock-in/out information DB 1D pertaining only to the employee working according to the work schedule out of the employees identified.

That is, out of the employees identified by the identification processing unit 11, the employee not working according to the work schedule is excluded from the retrieval result.

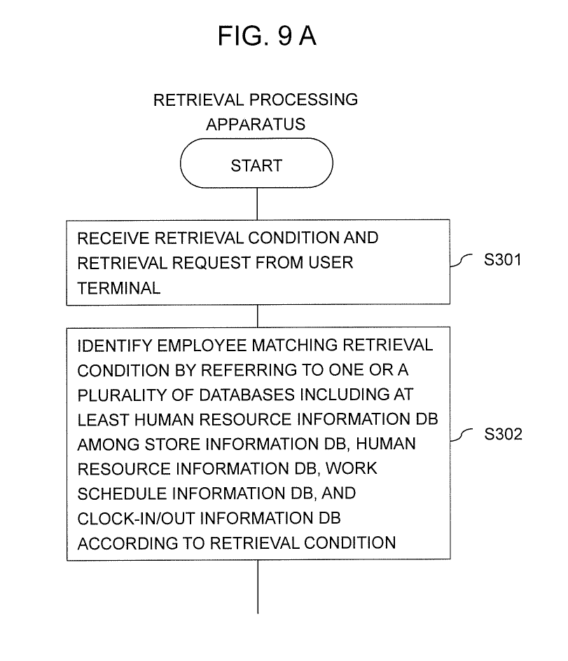

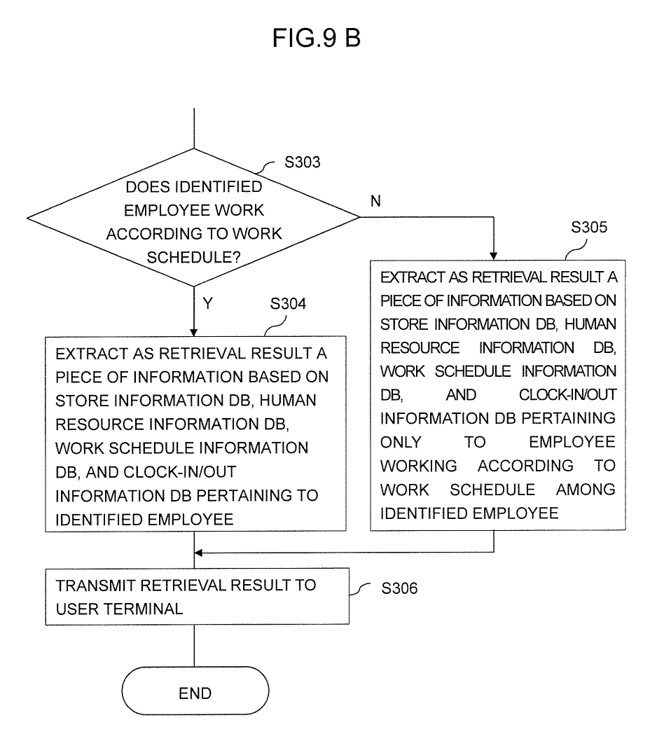

Next, the flow of processing performed by the retrieval processing apparatus 4 according to the present embodiment will be described with reference to FIG. 9.

Note that the flow of processing in which the retrieval processing apparatus 4 acquires clock-in/out information of an employee from a time recorder 31 is similar to that of the processing described with reference to FIG. 6.

First, as with the first embodiment, the retrieval processing apparatus 4 receives a retrieval condition and a retrieval request from a user terminal 2 on a predetermined website providing an information retrieval service (S301), and identifies an employee matching the retrieval condition by referring to one or a plurality of databases including at least the human resource information DB 1B among the store information DB 1A, the human resource information DB 1B, the work schedule information DB 1C and the clock-in/out information DB 1D according to the retrieval condition (S302).

The determination processing unit 41 then executes the determination processing of referring to the work schedule information DB 1C and the clock-in/out information DB 1D for all the employees identified and determining whether or not the employees work according to a work schedule, on the basis of work schedule information and clock-in/out information of the employees identified by the identification processing unit 11 (S303).

When it is determined as a result of the determination processing that the work schedule information matches the clock-in/out information for all the employees identified and that the employees work according to the work schedule, the extraction processing unit 12 extracts, as a retrieval result, a piece of information based on the store information DB 1A, the human resource information DB 1B, the work schedule information DB 1C and the clock-in/out information DB 1D pertaining to the identified employees (S304).

On the other hand, when it is determined as a result of the determination processing in S303 that there is an employee not working according to the work schedule, the extraction processing unit 12 extracts, as a retrieval result, a piece of information based on the store information DB 1A, the human resource information DB 1B, the work schedule information DB 10 and the clock-in/out information DB 1D pertaining only to the employee working according to the work schedule out of the employees identified (S305).

The extracted retrieval result is put into a predetermined form or the like and transmitted to the user terminal 2 (S306).

As a result, information pertaining to the employee not working according to the work schedule can be excluded from the retrieval result so that accuracy of information can be expected.

In the retrieval processing apparatus 4 of the second embodiment, the extraction processing unit 12 extracts, as the retrieval result, the information based on the store information DB 1A, the human resource information DB 1B, the work schedule information DB 1C and the clock-in/out information DB 1D pertaining only to the employee working according to the work schedule out of the employees identified by the identification processing unit 11 on the basis of the result of determination made by the determination processing unit 41. On the other hand, a variation of the second embodiment can be adapted such that the extraction processing unit 12 extracts, as a retrieval result, a piece of information based on the store information DB 1A, the human resource information DB 1B, the work schedule information DB 1C and the clock-in/out information DB 1D pertaining to an employee working according to a work schedule out of employees identified by the identification processing unit 11 and extracts, as a retrieval result, a piece of information based on the store information DB 1A, the human resource information DB 1B and the clock-in/out information DB 1D pertaining to an employee not working according to a work schedule, on the basis of a result of determination made by the determination processing unit 41. That is, a current work status of an employee indicated by the clock-in/out information is considered accurate even when the employee does not work according to the work schedule, so that accurate information can be provided to a user by extracting not work schedule information in which the current work status is not accurately reflected but the clock-in/out information as information pertaining to the work status of the employee.

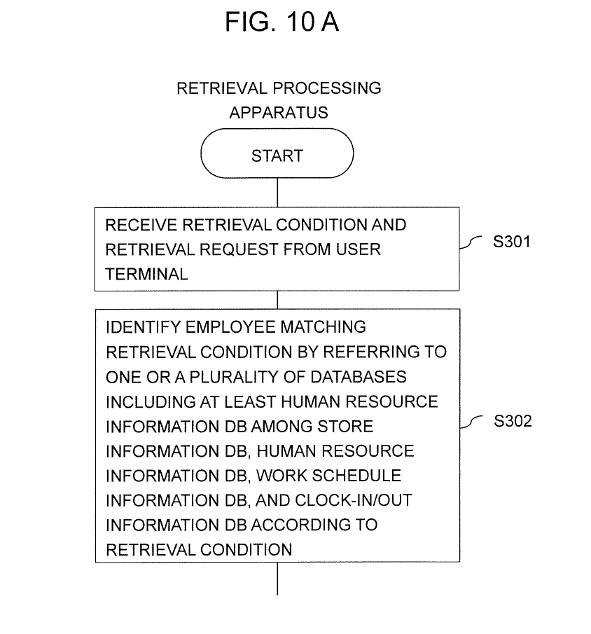

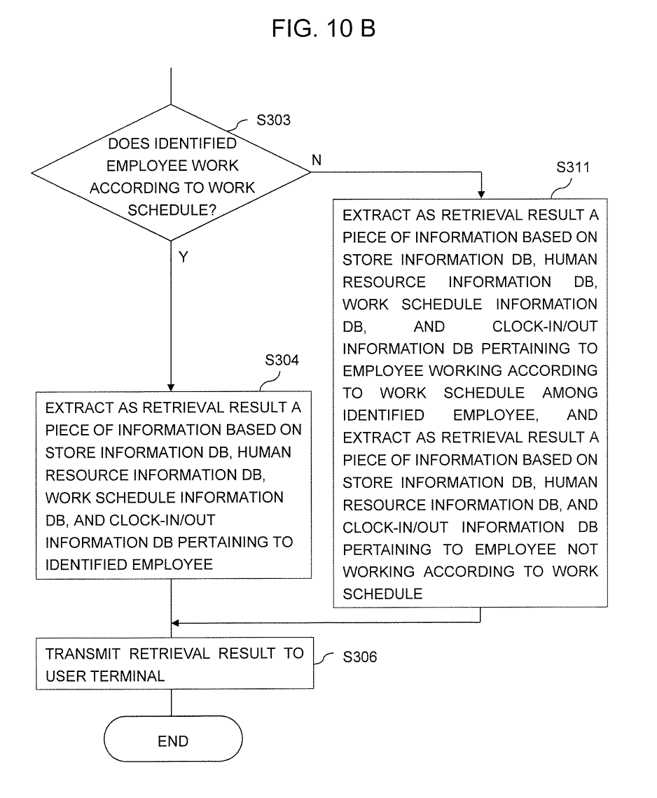

FIG. 10 illustrates the flow of processing performed in this case by the retrieval processing apparatus 4. Note that for convenience of description, processing in FIG. 10 similar to the processing illustrated in FIG. 9 will be assigned the same processing number as that assigned in FIG. 9.

As with the processing performed in the second embodiment described with reference to FIG. 9, the retrieval processing apparatus first receives a retrieval condition and a retrieval request from the user terminal 2 (S301), and identifies an employee matching the retrieval condition (S302).

After that, the determination processing unit 41 executes determination processing of determining whether or not all the employees identified work according to a work schedule (S303).

When it is determined as a result of the determination processing that the work schedule information matches the clock-in/out information for all the employees identified and that the employees work according to the work schedule, the extraction processing unit 12 extracts, as a retrieval result, a piece of information based on the store information DB 1A, the human resource information DB 1B, the work schedule information DB 1C and the clock-in/out information DB 1D pertaining to the identified employees (S304).

On the other hand, when it is determined as a result of the determination processing in S303 that there is an employee not working according to the work schedule, the extraction processing unit 12 in the present example extracts, as a retrieval result, a piece of information based on the store information DB 1A, the human resource information DB 1B, the work schedule information DB 1C and the clock-in/out information DB 1D pertaining to an employee working according to a work schedule out of the employees identified and extracts, as a retrieval result, apiece of information based on the store information DB 1A, the human resource information DB 1B and the clock-in/out information DB 1D pertaining to the employee not working according to the work schedule (S311).

The extracted retrieval result is put into a predetermined form or the like and transmitted to the user terminal 2 (S306).

According to this example, accurate information based on current clock-in/out information can be provided to the user. One can thus grasp the whereabouts of a desired employee at the present time or whether an employee works according to a work schedule indicated in advance as the retrieval result, whereby the user can avoid the inconvenience that the desired employee is absent on the date and time and at the location indicated as the retrieval result on his visit.

The retrieval processing apparatuses 1 and 4 of the aforementioned embodiments may also be adapted to make the employee carry a mobile terminal such as a mobile phone capable of data communication and equipped with a Global Positioning System (GPS) function and acquire location information of the employee acquired by the GPS.

A more accurate location of the employee can thus be provided to the user by reflecting the location information in the retrieval result.

Moreover, one can grasp whether or not the employee actually works at a location indicated in the clock-in/out information by collating the clock-in/out information acquired from the time recorder 31 and the location information, whereby more accurate information can be provided to the user by extracting information on the employee as the retrieval result only when the employee actually works at the location indicated.

Note that in the retrieval processing apparatuses 1 and 4 of the aforementioned embodiments, the retrieval item or retrieval result can be modified as appropriate by adding information other than the aforementioned information as appropriate or hiding predetermined information. It can be adapted to display popularity acquired from a result of a questionnaire on a store or hide a name of an employee, for example.

1. A retrieval processing apparatus which retrieves working hours and a workplace of an employee who can address a request of a user and is configured to be able to communicate with a user terminal used by the user through a network, the apparatus comprising:
a human resource information storage unit that stores human resource information related to an attribute or capability of an employee;
a work schedule information storage unit that stores work schedule information of an employee;
a retrieval request reception unit that receives, from the user terminal, a retrieval condition for an employee who can address the request of the user and a retrieval request to retrieve an employee matching the retrieval condition;
an identification processing unit that identifies the employee matching the retrieval condition by referring to one or a plurality of storage units including at least the human resource information storage unit among the human resource information storage unit and the work schedule information storage unit according to the retrieval condition;
an extraction processing unit that extracts, as a retrieval result, a piece of information based on the human resource information storage unit and the work schedule information storage unit pertaining to the employee identified; and
a result transmission unit that transmits the extracted retrieval result to the user terminal.

2. The retrieval processing apparatus according to claim 1, further comprising a clock-in/out information storage unit that stores clock-in/out information of the employee,
wherein the identification processing unit identifies the employee matching the retrieval condition by referring to one or a plurality of storage units including at least the human resource information storage unit among the human resource information storage unit, the work schedule information storage unit and the clock-in/out information storage unit according to the retrieval condition, and
the extraction processing unit extracts, as a retrieval result, a piece of information based on the human resource information storage unit, the work schedule information storage unit, and the clock-in/out information storage unit pertaining to the employee identified.

3. The retrieval processing apparatus according to claim 2, wherein
the retrieval processing apparatus is configured to be able to further communicate with a time recorder acquiring the clock-in/out information of the employee through the network, and
further includes a clock-in/out information reception unit that receives the clock-in/out information of the employee from the time recorder.

4. The retrieval processing apparatus according to claim 2, further comprising a determination processing unit that refers to the work schedule information storage unit and the clock-in/out information storage unit and determines whether or not the identified employee works according to a work schedule on the basis of the work schedule information and the clock-in/out information of the identified employee,
wherein the extraction processing unit extracts, as a retrieval result, a piece of information based on the human resource information storage unit, the work schedule information storage unit and the clock-in/out information storage unit pertaining only to an employee working according to the work schedule out of the identified employee, on the basis of a determination on whether or not the identified employee works according to the work schedule.

5. The retrieval processing apparatus according to claim 4 wherein, on the basis of the determination on whether or not the identified employee works according to the work schedule, the extraction processing unit extracts, as a retrieval result, a piece of information based on the human resource information storage unit, the work schedule information storage unit and the clock-in/out information storage unit pertaining to the employee working according to the work schedule among the identified employee and extracts, as a retrieval result, a piece of information based on the human resource information storage unit and the clock-in/out information storage unit pertaining to an employee not working according to the work schedule.

6. A retrieval processing method employed to retrieve working hours and a workplace of an employee who can address a request of a user, wherein a computer configured to be able to communicate with a user terminal used by the user through a network includes:
a human resource information storage unit that stores human resource information related to an attribute or capability of an employee; and
a work schedule information storage unit that stores work schedule information of an employee, and executes:
processing that receives, from the user terminal, a retrieval condition for an employee who can address the request of the user and a retrieval request to retrieve an employee matching the retrieval condition;
processing that identifies the employee matching the retrieval condition by referring to one or a plurality of storage units including at least the human resource information storage unit among the human resource information storage unit and the work schedule information storage unit according to the retrieval condition;
processing that extracts, as a retrieval result, a piece of information based on the human resource information storage unit and the work schedule information storage unit pertaining to the employee identified; and
processing that transmits the extracted retrieval result to the user terminal.

7. A non-transitory computer-readable medium which retrieves working hours and a workplace of an employee who can address a request of a user, wherein a computer configured to be able to communicate with a user terminal used by the user through a network includes:
a human resource information storage unit that stores human resource information related to an attribute or capability of an employee; and
a work schedule information storage unit that stores work schedule information of an employee, and the computer program causes the computer to execute:
processing that receives, from the user terminal, a retrieval condition for an employee who can address the request of the user and a retrieval request to retrieve an employee matching the retrieval condition;
processing that identifies the employee matching the retrieval condition by referring to one or a plurality of storage units including at least the human resource information storage unit among the human resource information storage unit and the work schedule information storage unit according to the retrieval condition;
processing that extracts, as a retrieval result, a piece of information based on the human resource information storage unit and the work schedule information storage unit pertaining to the employee identified; and
processing that transmits the extracted retrieval result to the user terminal.

8. The retrieval processing apparatus according to claim 3, further comprising a determination processing unit that refers to the work schedule information storage unit and the clock-in/out information storage unit and determines whether or not the identified employee works according to a work schedule on the basis of the work schedule information and the clock-in/out information of the identified employee,
wherein the extraction processing unit extracts, as a retrieval result, a piece of information based on the human resource information storage unit, the work schedule information storage unit and the clock-in/out information storage unit pertaining only to an employee working according to the work schedule out of the identified employee, on the basis of a determination on whether or not the identified employee works according to the work schedule.

9. The retrieval processing apparatus according to claim 8 wherein, on the basis of the determination on whether or not the identified employee works according to the work schedule, the extraction processing unit extracts, as a retrieval result, a piece of information based on the human resource information storage unit, the work schedule information storage unit and the clock-in/out information storage unit pertaining to the employee working according to the work schedule among the identified employee and extracts, as a retrieval result, a piece of information based on the human resource information storage unit and the clock-in/out information storage unit pertaining to an employee not working according to the work schedule.
